(19) United States
(12) Patent Application Publication
(10) Pub. No.: US 2007/0299692 A1
(43) Pub. Date: Dec. 27, 2007

(54) Electronic medical documentation and assessment system

(76) Inventor: Kristi Lee Sonsteby, Chico, CA (US)

Correspondence Address: Kristi Sonsteby, 3352 Summit Ridge Terrace, Chico, CA, 95928, US

(21) Appl. No.: 11/450,050

(22) Filed: Jun. 9, 2006

(51) Int. Cl. G06F 19/00

(52) U.S. Cl. 705/3

(57) ABSTRACT

A documentation system that allows adequate control of documentation in addition to an assessment of skills of the professionals involved includes plurality of software modules, each software module dedicated to a particular disease process or body system. Each software modules provides a checklist of assessment steps or an anatomical diagram of a particular body system or medical terminology. The medical data is accessed by inputting the abbreviations of a particular disease process or medical term displayed on an electronic device. It can then be downloaded to a PC and printed out in hard copy to be temporarily placed on the chart of the patient during an acute-episode, incident or accident or be permanently placed in the patient's chart to describe the patient's condition. In addition the pertinent medical data may be given to the patient to assist the patient in understanding his/her disease process, medical condition or medical terms.

### FIELD OF THE INVENTION

The present invention pertains in general to medical documentation system and medical patient education systems.

### BACKGROUND OF THE INVENTION

Documentation systems in the health care field have seen increased demand due to the increasing liability in that industry. The need for documentation systems is especially acute in present day health care systems to insure that well-run institutions remain in business. This is especially true when considering the fact that larger and larger numbers of individuals are being processed by the health care systems. It is this increased number of patients that provides the increased demand for documentation.

One type of problem that occurs in the documentation procedure of present day health care institutions is that involved with the nurse/patient relationship. When a patient is entered into the hospital, it is necessary to quickly identify the patient's condition and flag this condition for the nursing staff, especially when an acute episode or accident is involved that requires specific follow-up care. Typically, the nursing staff runs in shifts, with each shift having to deal with a relatively large number of patients. To insure that there is continuity of care between two shifts, it is important that each nurse entering a new shift has properly recorded all information concerning each of the patients. Typically, the only information that the nurse has on this patient is the chart. In order to adequately access a problem with the patient to determine what action to take and how often, the nurse must be able to quickly review the chart to determine the complete status of the patient and then make a determination as to what the problem is. Further, the nurse must document everything that has been done during this decision-making process. This can present a problem to any health care professional in that the appropriate medical terminology, etc., is not always fresh in their mind. This is especially true when handling a number of different anatomical systems such as the cardiovascular system, the genitourinary system, etc. To insure more complete documentation, it is desirable to provide a system whereby the health care professional can have ready access to the specific procedures that must be performed under any situation and clearly and succinctly document these procedures with the appropriate medical terminology or correct anatomical diagram.

Another type of problem that occurs in the healthcare field is that of incomplete understanding on the part of a patient of his/her own disease process. Physicians are called upon to explain a patient's problem in language, which is unfamiliar and not easily understood or retained by the patient. To insure more complete understanding it is desirable to provide the patient with a clear, permanent picture of the problem along with the appropriate descriptive terminology.

### SUMMARY OF THE INVENTION

The present invention pertains in general to documentation systems, and more particularly, to documentation system that allows adequate control of documentation involved in the health care industry in addition to an assessment of skills of the professionals involved by utilizing an electronically displaying method.

The present invention generally includes a variety of software modules related to medical charting issues. The software modules are incorporated into an electronic display device such as a dedicated electronic display device, a personal digital assistant or a personal computer.

A dedicated electronic display device in accordance with the present invention may resemble a pocket calculator with a visible display on which the various information in the various software modules can be displayed. For example, the dedicated electronic display device may include software modules on basic medical terminology, lab values, basic physical assessments, common care procedures, a glossary of medical terms, guidelines for charting for Medicare and generic brand name medication comparison's. These various modules are accessible to the operator of the dedicated electronic display device for educational and reference purposes. The dedicated electronic display device may also include an output port either hardwired infrared or other wireless communication that allows information from the device to be sent to a printer for printing out for incorporation into the patient's paper medical chart. In addition the electronic display device may include a data port for output to an electronic support system.

It is also specifically contemplated that the modules of the present invention may be incorporated into a personal digital assistant type of device, personal computer, or another form of electronic display device. For example, the electronic display device may include a software module that includes diagrams of various body systems and body parts, which can be annotated through use of the electronic display device. Once appropriate annotations are made the anatomical depiction may as annotated may be sent to a printer and printed out on adhesive back paper for incorporation into the patient's paper medical records or the annotated anatomical depiction can be printed out to provide into a patient for patient education use or the annotated diagram may be downloaded into a digital medical record storage system.

In addition, the present invention may be utilized in several different languages. Thus, the invention may also include a module to translate medical terminology into different languages for the benefit of patients who do not speak English or a health care professional who speaks English as a second language. The invention may also be made available in various languages to be utilized by the general public in the language with which they are most comfortable communicating.

Thus, the present invention is intended for use by healthcare professionals such as physicians and nurses as well as being accessible for use by the general public for educational purposes. It is contemplated that a dedicated electronic display device in accordance with the present invention may be provided directly to the public for access and reference to medical information for self-education as well as reference purposes.

### BRIEF DESCRIPTION OF THE DRAWINGS

FIG. 1 is a schematic depiction of an electronic displaying device FIG. 1A. depicts a. hand held electronic type display device FIG. 1B. depicts a PDA type electronic display device FIG. 1C. depicts a PC monitor electronic display device;

FIG. 2 is a schematic depiction of the hand held electronic display device which is retrieving pertinent medical data FIG. 2A. depicts a hand held electronic type display device, FIG. 2B. depicts a PDA type electronic display device 3C. depicts a PC monitor electronic display device;

FIG. 3 illustrates a detail of a checklist display associated with the assessment portion of the present invention; FIG. 3A. depicts an Anatomical diagram FIG. 3B. depicts a Body system FIG. 3C. depicts Medical term FIG. 3D. depicts Lab value FIG. 3E. depicts Generic/brand name medication FIG. 3F. depicts Medicare charting information;

FIG. 4 illustrates the method to print out the pertinent medical data at attach to the patients chart; 4.A. depicts PDA type electronic display device attached to a printer 4.B. depicts PC monitor electronic display device attached to a printer;

FIG. 5 illustrates an exemplary anatomy diagram associated with the assessment and patient teaching portion of the present invention displaying on the electronic displaying device 5.A. depicts Hand held electronic type display device 5.B. depicts PDA type electronic display device 5.C. depicts PC monitor electronic display device;

FIG. 6 illustrates a detail of the electronic display device documentation system attaching to a printer 6.A. depicts a PDA type electronic type device attached to a printer 6.B. depicts a PC monitor electronic display device attached to a printer;

FIG. 7 illustrates the various locations of the printed out medical data for use in the patients chart, including the chart divider, the nurses notes and the physicians progress notes; and 7.A. depicts Physicians progress notes 7.B. depicts Nurses notes 7.C. depicts chart divider; and

FIG. 8 illustrates a detail of input in the keyboard Cardio and that pertinent medical data displaying on the electronic device.

Appendix A attached hereto contains additional disclosure in accordance with the present invention. Appendix A is hereby incorporated into this application in its entirety by reference.

### DETAILED DESCRIPTION OF THE INVENTION

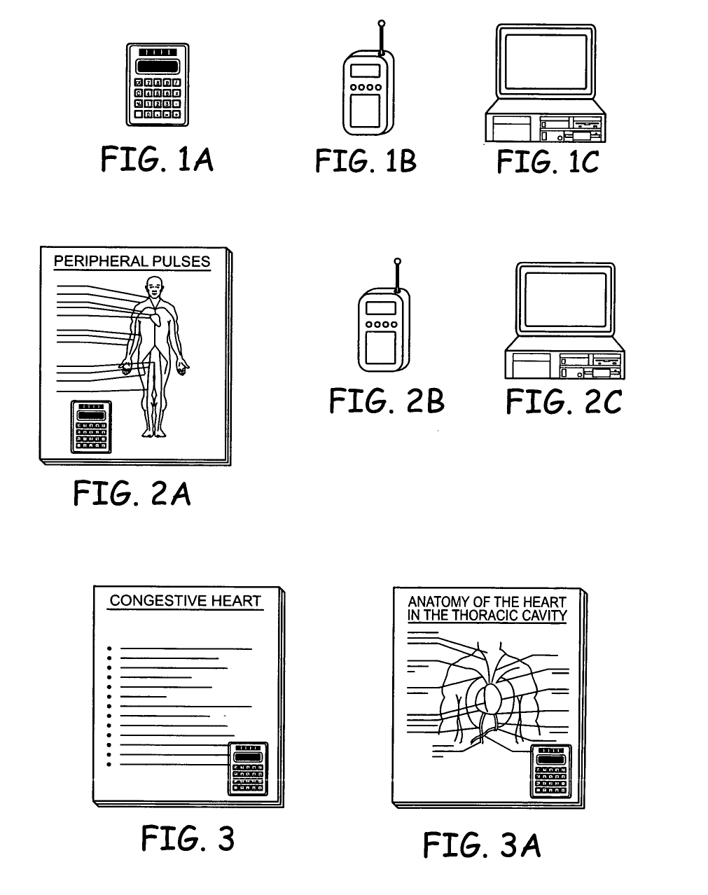

Referring to FIG. 1 the documentation system of the present invention includes a plurality of medical topics.

1. Each identified by a separate software package title

2. And a separate abbreviated name made up of letters

3. Each software program corresponds with a different body system, such as urinary or cardiovascular, and includes either a checklist or medical definitions

4. With all of the information necessary for a thorough assessment, or an anatomical diagram

5. with appropriate medical data distinguishing the various body parts.

6. or pertinent medical data for use in diagnostic procedures, or acting as a medical dictionary of meanings of terms or medications In the preferred embodiment, there are at least

7. different software packages, each contained in a software program.

The software modules include

Volume 1—Basic medical terminology

Volume 2—Lab Values plus

Volume 3—Basic physical assessments

Volume 4—Common care procedures

Volume 5—Glossary of medical terms

Volume 6—Charting for Medicare

Volume 7—Generic/brand name comparisons

In use, the healthcare professional accesses the appropriate electronic module by selecting the appropriate title to determine which term is to be associated with a particular patient. For example, if a patient has entered into the hospital for a cardiovascular problem, the cardiovascular electronic module. CARDIO is selected and the appropriate medical information is displayed. This assessment and/or diagnostic information is then utilized to aid the health care professional in the subsequent diagnostic procedures. After the proper assessment steps have been taken and documented, the anatomy of the heart in the thoracic cavity is selected and utilized when explaining to the patient his/her condition. This information is then given to the patient in order to aid his/her retention of the information. The electronic display device may also be attached to a printer and the medical data could be downloaded for electronic storage or in a patient's medical chart.

Referring now to FIG. 2 there is illustrated a blowup of the current invention displayed at the nurse's station. The electronic display type devices in the display rack allowing the titles, 2 to be distinguished and the appropriate medical terminology or medical abbreviations for the desired medical term to be selected.

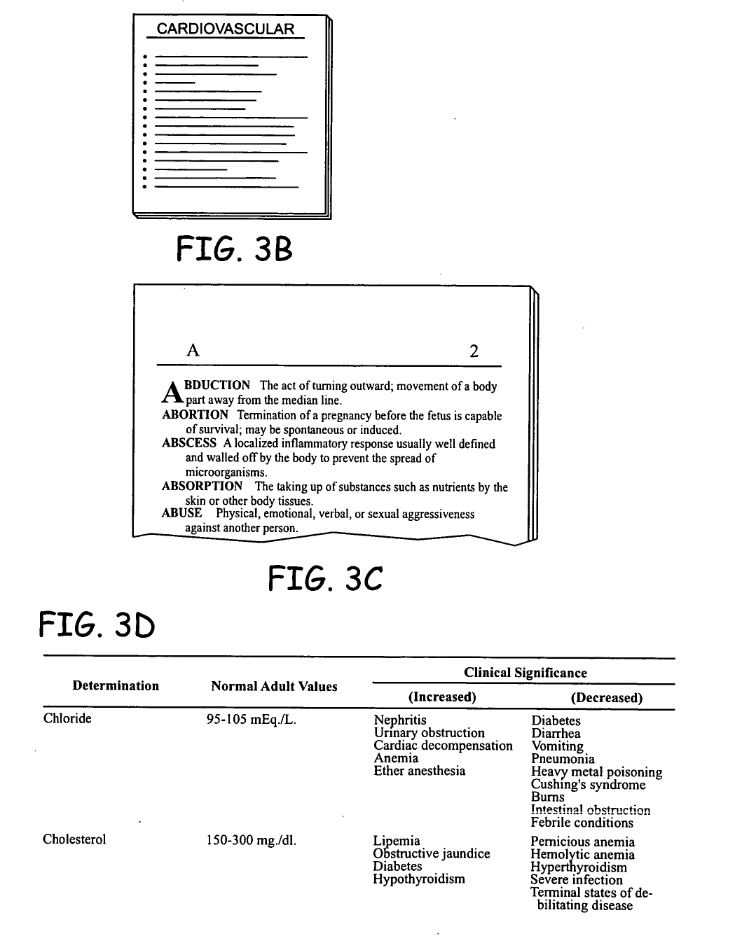

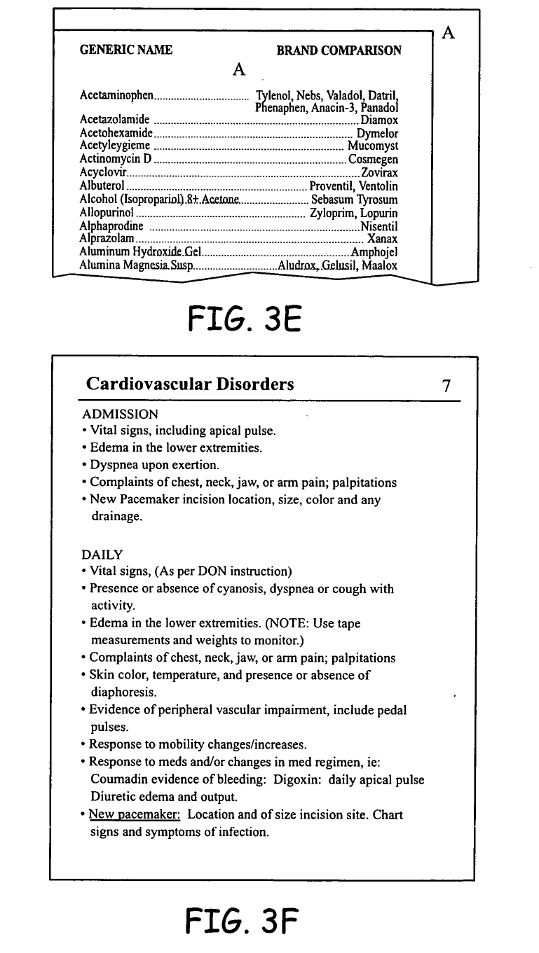

Referring now to FIG. 3 there is illustrated a detail of one of the assessment and/or diagnostic checklist electronic modules, of which there are presently 7. This electronic module contains appropriate steps in proper assessment and/or documentation of the patient's condition. FIG. 3a depicts an exemplary anatomical diagram, which can be brought up on the electronic display and annotated as need be. The anatomical diagram can then be sent to a printer or stored in an electronic retrieval system. The anatomical diagram can then be printed out for incorporation into the patient's paper medical record as need be. FIG. 3b depicts a body system check list which can be utilize as a memory prompter or reminder system for the health care professional to ascertain that the healthcare professional performs appropriate testing or requests appropriate procedures related to the various body systems. FIG. 3c depicts an exemplary medical terminology glossary, which then can be accessed on the electronic display to look up the meaning of unfamiliar terms or provide explanations on familiar terms and patient contact situations. FIG. 3d is an exemplary list of expected normal laboratory values for various laboratory tests. The lab value listing also provides a listing of the clinical significance of abnormal laboratory values. FIG. 3e depicts a listing of generic and brand names of various common pharmaceuticals or medications. The healthcare professional can call up the generic name brand comparison on the electronic display for reference to cross-reference the various names used for various medications.

FIG. 3f depicts an exemplary display of Medicare card information that is accessible for viewing on the electronic display. The healthcare professional can access the various Medicare charting information to assure that appropriate notations are made in the patient's medical chart to satisfy the requirements for billing of Medicare.

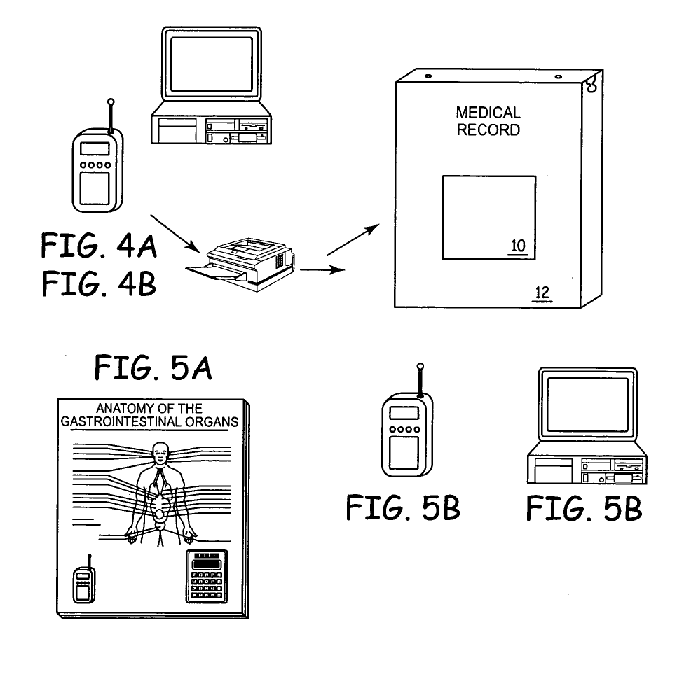

FIG. 4 illustrates a method to provide printouts of pertinent medical data that can then be incorporated into the patient's paper medical charts. FIG. 4a depicts a PDA type electronic display device equipped in accordance with the present invention that can be attached to a printer via a hardwire connection or an infrared connection to print out the information for incorporation into the patient's medical chart. FIG. 4b depicts the utilization of a personal computer to printout similar information.

FIG. 5 illustrates one of the many anatomical diagrams associated with the assessment and teaching portion of the present invention, which can be displayed on the display of an electronic display device. For example, a hand held type electronic display device that is programmed with hardware or firmware to provide access to the various modules of the present invention, or a PDA type electronic display device as depicted in FIG. 5b or a personal computer electronic display device as depicted in FIG. 5c.

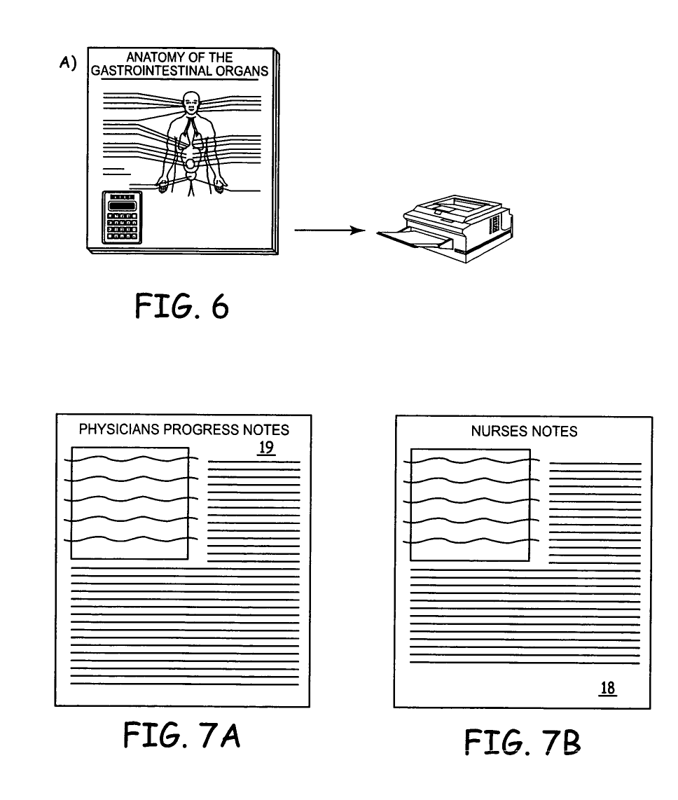

Referring to FIG. 6, the present invention may also include a dedicated electronic display device documentation system, which can be operably attached to a printer thus the dedicated electronic display device can be utilized to printout various information included in the medical documentation system for incorporation into the patients paper medical chart.

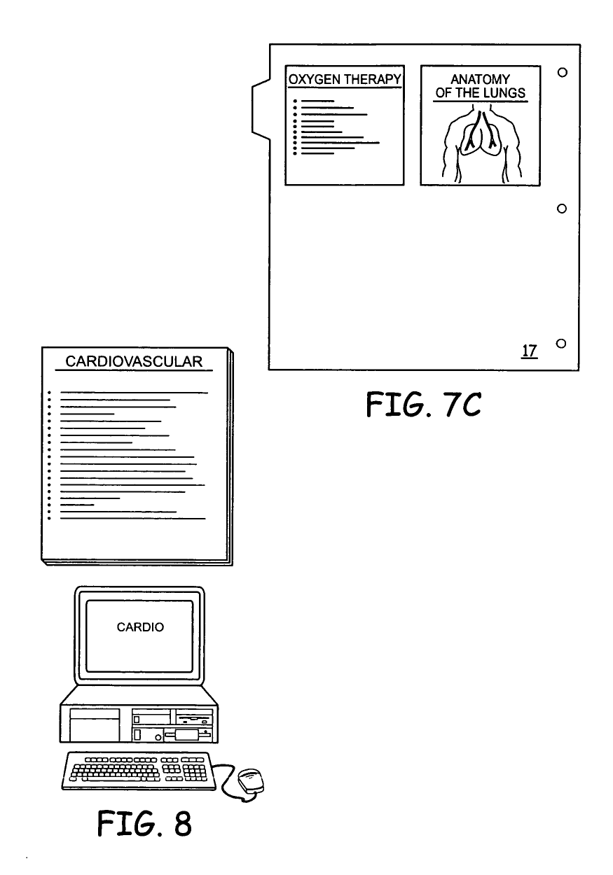

Referring to FIG. 7, FIG. 7 illustrates the various locations within the patients paper medical chart in which printed out medical data may be incorporated. FIG. 7a depicts the physician's progress notes. FIG. 7b depicts information incorporated into the nurse's notes. FIG. 7c indicates that adhesive back printouts produced by the present invention can also be adhesively attached to the chart divider. Referring to FIG. 8, the keyboard input of the shorthand term cardio is depicted along with pertinent medical data displayed on the screen of an electronic device, in this case, a personal computer, though the material may also be displayed on the information display of a dedicated electronic device or a personal digital type electronic device.

In addition, the present invention may be utilized in several different languages. Thus, the invention may also include a module to translate medical terminology into different languages for the benefit of patients who do not speak English or a health care professional who speaks English as a second language. The invention may also be made available in various languages to be utilized by the general public in the language with which they are most comfortable communicating. In particular, the dedicated electronic display of the present invention may be adapted to operate in any language or in several languages.

The claims provided herein are to ensure adequacy of the present application for establishing foreign priority and for no other purpose.

### ADDITIONAL ASPECTS OF THE INVENTION

1. A documentation electronic apparatus for use in association with a patient's medical chart.

2. The documentation electronic apparatus of claim 1 wherein each said display can be printed and placed in the patient's medical record.

3. The documentation apparatus of claim 1 wherein each said display can be downloaded to a data storage system.

4. The documentation apparatus of claim 1 wherein each of said checklist labels contains a plurality of predetermined documentation steps, each said textural description preceded by an indicator marker.

5. A method for temporarily documenting care in a medical environment and in association with patients medical chart, comprising:
defining a plurality of medical occurrences or disease processes;
selecting a medical occurrence or disease process, selecting an associated body system;
providing a plurality of charting reminder sheets of paper, each dimensional to fit in a patient's medical chart;
providing a plurality of providing a plurality of checklist documentation steps in text relating to the selected medical occurrence or disease process;
providing a plurality of anatomical labels, each containing an anatomical diagram of a particular body system and salient medical terminology for the associated medical occurrence or disease process;
providing on each of the said titles of the associated medical occurrence, disease process, or body system, and inputting the abbreviations into the electronically keypad device and use the information for follow-up for an acute episode, incident, or accident is presented, and attaching the electronic display device to a PC and printing on a sheet of paper into the patients medical chart for the duration of the follow-up procedure; and
removing the charting reminder sheet of paper, when the follow-up procedure is completed.

6. A permanent method for documentation verification in a medical environment, and in association with a patients chart, compromising:
defining a plurality of medical occurrences or disease processes, selecting a medical occurrence or disease process, selecting a medical occurrence or disease process, selecting an associated body system or medical terminology;
providing a plurality of software modules fit in the physician's progress notes or the nurse's notes, and providing a plurality of checklist labels containing documentation steps in text relating to the selected medical occurrence or disease process or medical term;
Providing a plurality of anatomical labels, each containing an anatomical diagram of a particular body system and salient medical terminology for the associated medical occurrence or disease process, providing on each of the said software modules with a title of the associated medical occurrence, disease process, or body system, inputting the abbreviated medical term into the keyboard which will display the pertinent medical data; and
need for documentation is presented download when the need for documentation is presented attaching the printed pertinent medical data to the physicians progress notes or nurses notes retaining in the chart as a permanent record of care.

7. A method of patient teaching in a medical environment, comprising:
defining a plurality of medical occurrences or disease processes, selecting a medical occurrence or disease selecting a medical occurrence or disease process selecting an associated body system;
providing a plurality of anatomical diagrams, each containing an anatomical diagram of a particular body system and salient medical terminology for the associated medical occurrence or disease process; and
providing on each of the said titles of the associated medical occurrence, disease process or body system, and printing out the pertinent medical data when the need to educate a patient arises, and giving the label to the patient after an explanation of his/her condition.

1. An electronic medical documentation and assessment system substantially as depicted and described herein.

2. A method of electronically documenting and assessing medical information substantially as depicted and described herein.
